(19) United States
(12) Patent Application Publication
(10) Pub. No.: US 2015/0178102 A1
(43) Pub. Date: Jun. 25, 2015

(54) SYSTEM-ON-CHIP, METHOD OF MANUFACTURE THEREOF AND METHOD OF CONTROLLING A SYSTEM-ON-CHIP

(71) Applicants: Markus Regner, Munich (DE); Vladimir Litovtchenko, Ebersberg (DE); Harald Luepken, Heimstetten (DE)

(72) Inventors: Markus Regner, Munich (DE); Vladimir Litovtchenko, Ebersberg (DE); Harald Luepken, Heimstetten (DE)

(73) Assignee: FREESCALE SEMICONDUCTOR, INC., Austin, TX (US)

(21) Appl. No.: 14/359,709

(22) PCT Filed: Nov. 23, 2011
(86) PCT No.: PCT/IB2011/055253

§ 371 Date: May 21, 2014

(51) Int. Cl. G06F 9/445; G06F 1/12; G06F 17/50

(52) U.S. Cl. CPC G06F 9/44505; G06F 17/505; G06F 1/12

(57) ABSTRACT

A system-on-chip comprises a plurality of functional domains. The plurality of functional domains comprise a first domain and a second domain, the first domain having a first active mode of operation and the second domain having a second active mode of operation different from the first active mode of operation. The system-on-chip also comprises a control unit operably coupled to the first and second domains and capable of placing the first domain in the first active mode and the second domain in the second active mode so that the first domain is in the first active mode and the second domain is in the second active mode substantially contemporaneously. The first active mode of operation is functionally different from the second active mode of operation.

### FIELD OF THE INVENTION

This invention relates to a system-on-chip control system, a method of manufacturing a system-on-chip, and a method of controlling a system-on-chip.

### BACKGROUND OF THE INVENTION

In the field of semiconductors, a so-called “System-on-Chip”, or SoC, is an integrated circuit on a single substrate that comprises useful, and sometimes necessary or essential, components of an electronic system or a computer. Such systems typically, but not exclusively, include digital, analogue, mixed-signal, and often radio-frequency modules.

For example, an SoC can comprise a number of processors and respective memory associated with said processors, in addition to other logic on the chip. Furthermore, the SoC can be notionally segregated into so-called “domains” or areas. A given domain comprises logic, and sometimes power circuitry to support execution of functionality locally and independently of other such domains. In this respect, the SoC can comprise multiple domains, each concerned with respective functional purposes. Furthermore, it is known for domains to have more than one mode of operation associated with device operation, for example a test mode, an application mode and a synchronisation mode.

In relation to such modes of operation, a known implementation of an SoC supports placing a domain in a particular mode of operation, for example a test mode, whilst other domains of the SoC remain in an idle state.

U.S. Pat. No. 6,983,398 relates to a technique for testing a device under test, for example a chip that includes a plurality of processors and a memory structure that stores test programs. One or more programs execute the test programs and generate test results. In response to the test results, the chip may be determined fault-free or faulty. This document also describes the processors executing test programs independently of each other.

International patent publication no. WO 2009/138819 relates to so-called multi-core devices that are switchable between synchronous and asynchronous modes. In order to switch between an asynchronous mode and a synchronous mode, a synchronisation step needs to be performed in order to change the states of the processing cores so that the states of the two cores are identical. Consequently, a reference processing module is described that comprises a set of reference stateful elements and a target processing module comprising a set of target stateful elements. A scan chain is provided and couples the reference processing module to the target processing module in a first mode. In a second mode, the scan chain is capable of synchronising the set of target stateful elements with the set of reference stateful elements in response to a synchronisation signal.

### SUMMARY OF THE INVENTION

The present invention provides a system-on-chip control system, a method of manufacturing a system-on-chip control system and method of controlling a system-on-chip device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 is a schematic diagram of a system-on-chip device for a system-on-chip control system constituting an embodiment of the invention;

FIG. 2 is a schematic diagram of the system-on-chip device of FIG. 1 in greater detail;

FIG. 3 is a schematic diagram of a system-on-chip device control system constituting an embodiment of the invention;

FIG. 4 is an event sequence diagram of messages and data communicated in the system-on-chip control system of FIG. 3;

FIG. 5 is a flow diagram of a method of controlling a system-on-chip device of FIG. 3 and constituting another embodiment of the invention;

FIG. 6 is a schematic diagram of a domain;

FIG. 7 is a schematic diagram of a first domain synchronisation arrangement; and

FIG. 8 is a schematic diagram of a second domain synchronisation arrangement.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

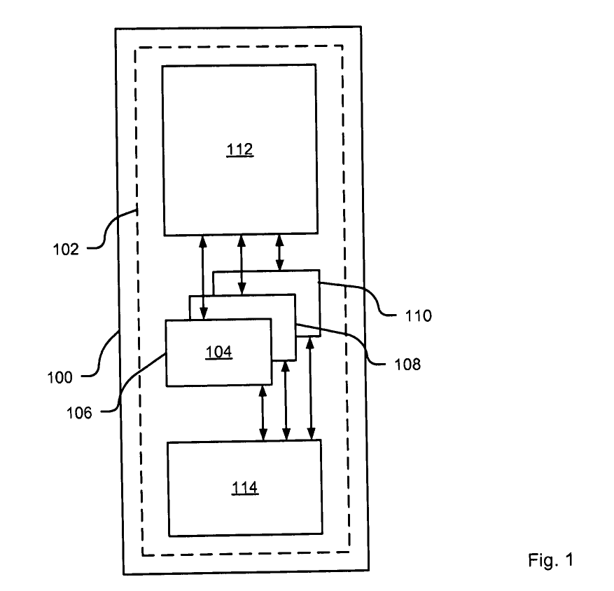

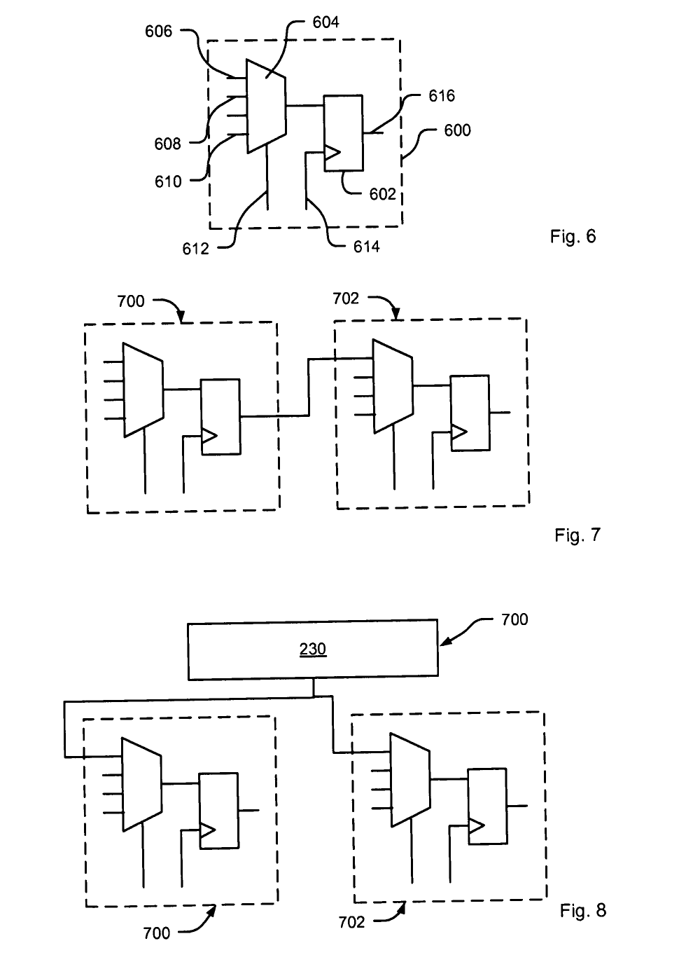

Referring to FIG. 1, an SoC device 100 shown herein comprises an integrated circuit 102 on a single die. The integrated circuit 102 is arranged, for example by logically segmenting or designating parts of the integrated circuit, so as to have a plurality of functional domains 104. In this example, the plurality of functional domains 104 comprises a first domain 106, a second domain 108, a third domain 110 and a fourth domain 300 (not shown in FIG. 1). Referring to FIG. 6, each domain can be represented as shown herein. The example of a domain 600 comprises one or more domain blocks comprising so-called Digital Flip-Flops (DFFs) 602. For DFFs that need to be configured and controlled according to embodiments described herein, the DFF 602 of each domain block is operably coupled to a multiplexer 604 or any other suitable switching device. During design of the SoC device 100, a domain is defined by the selection of domain blocks from the integrated circuit 102. The multiplexer 604 comprises a plurality of inputs, for example a synchronisation input 606, a scan input 608 and a normal or intended function input 610. The multiplexer 604 also has a mode select input 612 and the DFF 602 has a clock input 614 and an output 616. The mode select input 612 of the multiplexer 604 allows different inputs to be coupled to the DFF 602, thereby enabling the DFF 602 to participate in different functional activities or modes, for example the synchronisation mode or the test mode described herein.

The skilled person should appreciate that the domains can be arranged to support a number of different functions, for example one or more of a number of applications functions which contribute to a purpose for providing the SoC device 100, a scan function, a self-test function, a synchronisation master function, a synchronisation slave function, and/or an error-injection function. As such, the domains can support a number of different corresponding domain modes, for example one or more of a number of functional domain modes, a scan mode, a self-test mode, a synchronisation master mode, a synchronisation slave mode and an error injection mode.

Referring back to FIG. 1, the first domain 106, the second domain 108, the third domain 110 and the fourth domain 300 may each be operably coupled to a mode controller unit 112 and a clock controller unit 114. The mode controller 112 comprises a module to control functionality on an SoC-wide basis, for example powering of one or more areas to be powered, clocking, control of clock dividers. Of course, the skilled person will appreciate that more than one module can be employed to provide some or all of the functionality. In this example, the first domain 106, the second domain 108, the third domain 110 and the fourth domain 300 is capable of operating in a selected one of a number of possible active modes of operation. This is distinct from being in an idle state. Examples of the active modes of operation, which are in this example domain modes, are: a test mode, such as a production test mode and/or a self-test mode, a scan mode, a synchronisation mode, an error-injection mode and an application mode. The application mode is a mode of operation in which a domain executes in accordance with programming written so that the SoC device 100 performs one or more intended applications. In this respect, and as mentioned above, the domain can have more than one application mode. Also, it should be noted that more than one synchronisation mode can be supported.

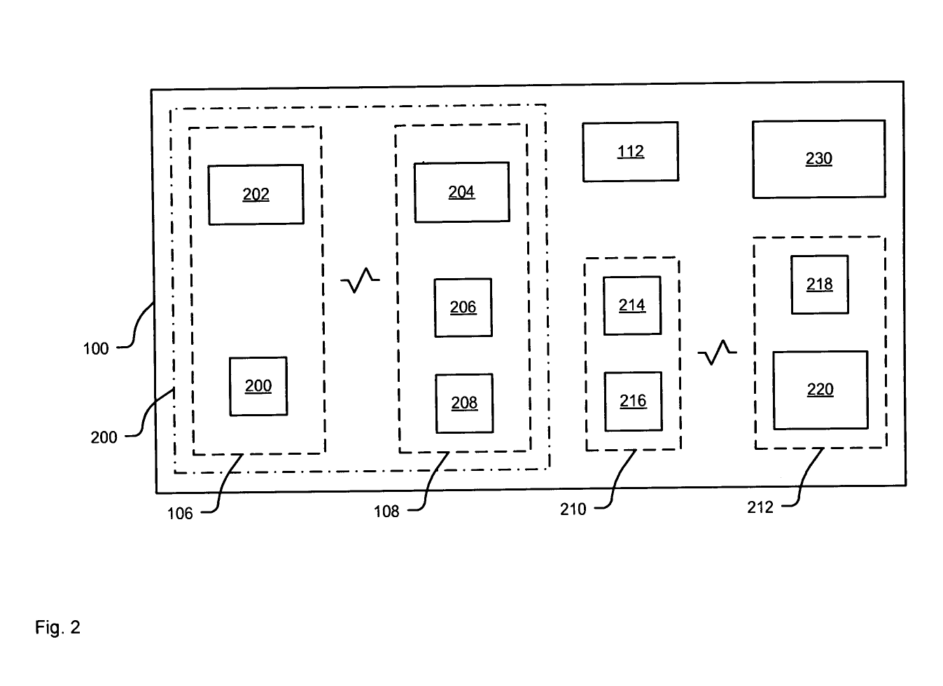

Turning to FIG. 2, and as mentioned above, during manufacture the integrated circuit 102 of the SoC device 100 is arranged so that a plurality of functional domains exists. In this respect, at least one design or functional criterion is set in relation to defining each domain so that, for example, the domain can operate in one or more of the active modes of operation. To this end, the first domain 106 has a first design or functional criterion associated therewith, the second design or functional domain 108 has a second criterion associated therewith, the third domain 110 has a third design or functional criterion associated therewith and the fourth domain 300 has a fourth design or functional criterion associated therewith. In another example, where two core-pairs are employed, it may be desirable for each pair of cores to operate in lock-step synchronism. However, when one core-pair is detected, for example by one or more so-called redundancy checkers, as not operating in lock-step, it is desirable to re-synchronise the core-pair in order to avoid execution of a lengthy reset procedure involving both core pairs and preventing the system from executing a desired application. Consequently, one functional criterion could be to support execution of the desired application whilst allowing a re-synchronisation of an erroneous core-pair without the need for a reset of the system.

Another example of a functional criterion applies to two cores running in a decoupled parallel mode. During operation, an application executing on one core acquires a need to perform a safety-critical measurement and so requests the other core to become part of a lock-step pair. The criterion would therefore be to permit a dynamic switch from the decoupled parallel mode to a lock-step mode without the need to perform the lengthy reset procedure for the whole system mentioned above.

A further example, which is analogous to the previous example, relates to the two cores running in lock-step mode when an application recognises a need to increase performance and so switch to the decoupled parallel mode. The criterion would therefore be to permit a dynamic switch from the lock-step mode to the decoupled parallel mode without the need to perform the lengthy reset procedure for the whole system mentioned above.

In this example, the integrated circuit 102 of the SoC device 100 is arranged so that the SoC device 100 comprises synchronisation domains 200, the synchronisation domains 200 can perform a number of functions of the type already described above. In relation to FIG. 2, the first domain 106 supports a first synchronisation mode of operation, for example a lock-step synchronisation mode, and a second synchronisation mode, for example a decoupled parallel synchronisation mode. Similarly, the second domain 108 also supports the first synchronisation mode of operation and the second synchronisation mode of operation. The first domain 106 also comprises a first logic area 200 constituting a logical built-in self-test area. Of course, the first domain 106 may comprise more built-in self-test areas than described in this example The first domain 106 also comprises a first core 202 operably coupled to the first logic area 200. In this example, the first core 202 is operably coupled to the first logic area 200, the first logical area supporting the modes of operation mentioned above, such as the self-test mode. In such a configuration, the first logic area 200 supports, for example, a scan chain structure. Of course, the skilled person will appreciate that one or more other modes of operation can be supported by appropriate configuration of the first core 204 and the first logic area 200 in the first domain 106. The second domain 108 comprises a second core 204 operably coupled to a second logic area 206 and a third logic area 208. In this example, the second core 204 is operably coupled to the second logic area 206 and the third logic area 208. The second and third logic areas 206, 208 support the modes of operation mentioned above, such as the self-test mode. In such a configuration, the second logic area 206 and the third logic area 208 are connected so as to support, for example, another scan chain structure. Of course, the skilled person will appreciate that one or more other modes of operation can be supported by appropriate configuration of the second core 204, the second logic area 206 and/or the third logic area 208.

In this example, the SoC device 100 also comprises a first memory built-in self-test area 210 and a second memory built-in self-test area 212. Again, the SoC device 100 may comprise more memory built-in self-test areas than described in this example, but the present example is limited to two memory built-in self-test areas in order not to distract the skilled reader from the teachings herein. The first memory built-in self-test area 210 comprises a first memory domain 214 and a second memory domain 216, each formed from respective notional partitions in accordance with one or more associated criteria. The second memory built-in self-test area 212 comprises a third memory domain 218, for example relating to a digital memory, and a fourth memory domain 220, for example relating to a Read-Only Memory (ROM) and/or other non-volatile memory.

The SoC device 100 also comprises the mode controller unit 112, which is operably coupled to the domains of the SoC device 100 described herein, and a synchronisation control unit 230.

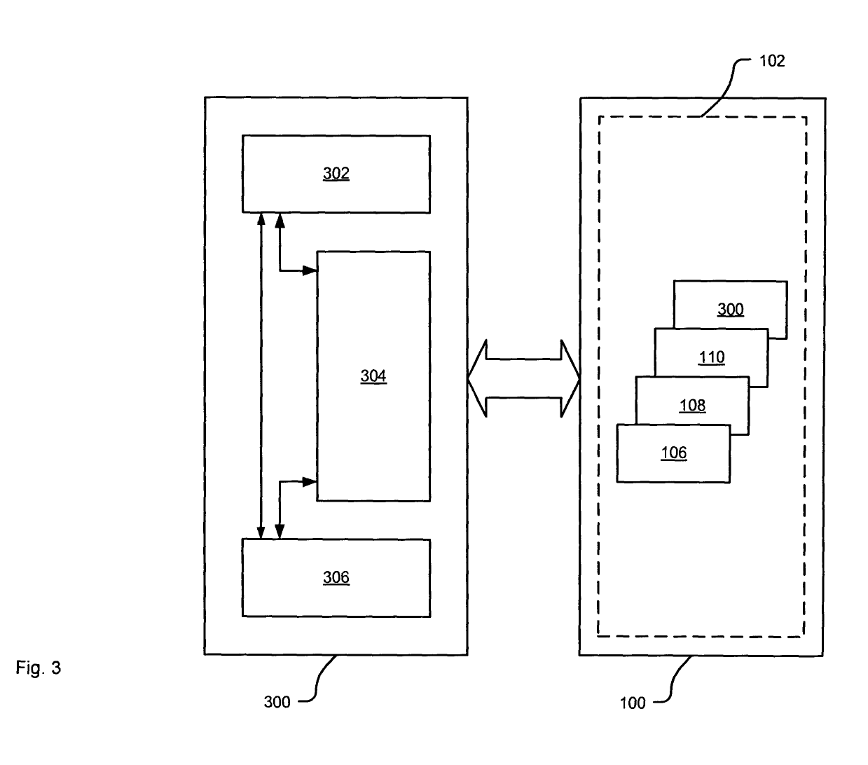

Referring to FIG. 3, a control unit 300 is operably coupled to the SoC device 100 and is therefore capable of communicating with the SoC device 100 in order to enable the modes of the plurality of functional domains of the SoC device 100 to be controlled. The control unit 300 is, in this example, external to the SoC device 100.

The control unit 300 comprises a data store comprising a plurality of registers 302 relating to the status of the control unit 300 and the domains 106, 108, 110, 300 of the SoC device 100. In this example, the plurality of registers 302 is used to store data relating to: the current configuration of the control unit 300; start and stop data to control each domain; synchronisation data when the control unit 300 serves as a synchronisation master; status data concerning the control unit 300; domains and any on-going processes, for example, processes that are incomplete, such as a synchronisation process between the first core 202 and the second core 204 that has not finished yet, and/or a self-check process of a domain that has not finished yet. The data store 302 is operably coupled to a control logic 304 and a clock request unit 306. The clock request unit 306 is responsible for controlling clock settings, for example setting and controlling clock dividers, programming Phase Locked Loops (PLLs) and/or observing PLL lock information. In this example, the control logic 304 implements a state machine, details of the functionality of which will be described later herein.

The above-described system can be operated in a number of exemplary ways. For the sake of conciseness, the operation of the system will be described in the context of synchronisation of the first core 202 and the second core 204 of the SoC device 100. However, the skilled person should appreciate that the control system can be employed to perform other tasks, for example to enter one or more of the domains into a test mode, for example a self-test mode.

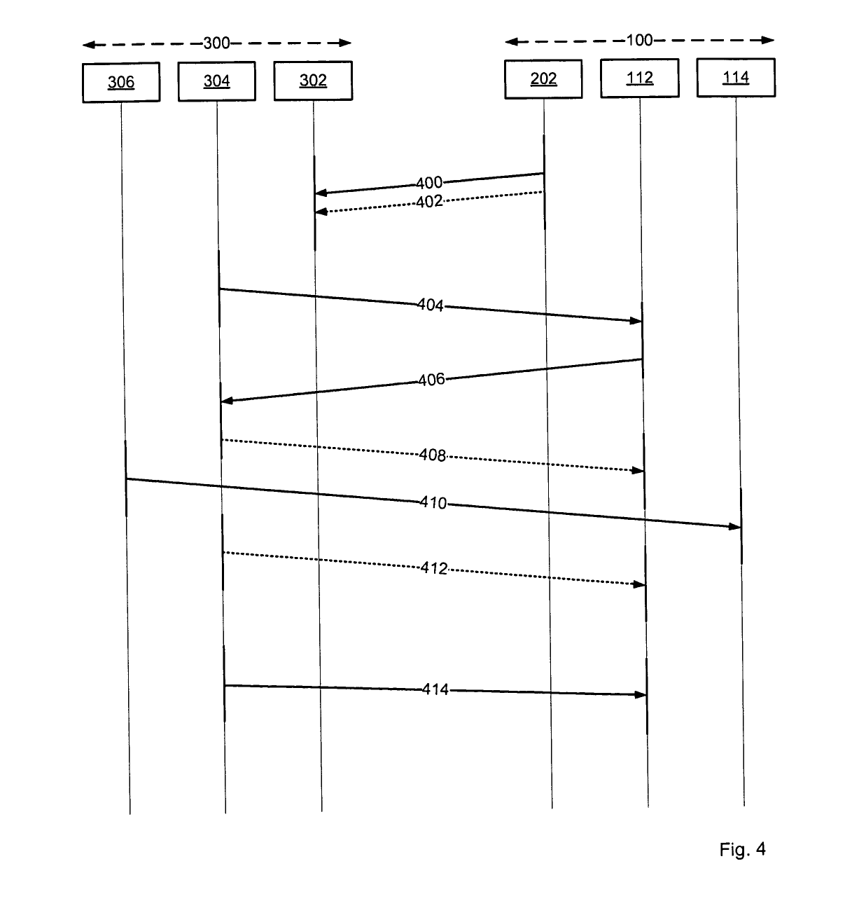

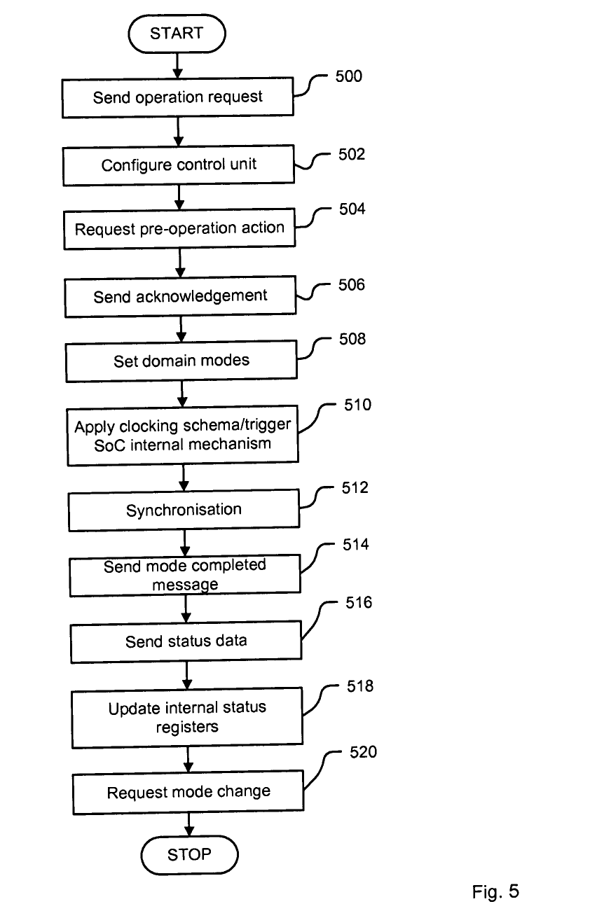

In operation (FIGS. 4 and 5), the first core 202 of the SoC device 100, in this example, sends (Step 500) the control unit 300 an operation request 400. To support the operation request 400, the first core 202 of the SoC device 100 also sends (Step 502) the data store 302 of the control unit 300 configuration data 402 to be stored in one or more of the registers in order to support the operation request 400. The data store 302 can be accessed via a system data interface of the SoC device 100, for example a slave bus interface used for configuration and/or data streaming, such as an Internet Protocol SkyBlue (IPS) interface, or a debug interface. Such interfaces can also be used to communicate the operation request 400 between the control unit 300 and the SoC device 100. In this example, the operation request 400 is a synchronisation request.

In response to the receipt of the operation request 400, the state machine 304 of the control unit 300 sends (Step 504) the mode controller unit 112 of the SoC device 100 a request for pre-operation action 404. In response thereto, the mode controller unit 112 sends (Step 506) an acknowledgement 406 back to the state machine 304. The acknowledgement 406 is required in case another pre-operation request has already been acted upon, resulting in parts of the SoC device 100 powering up, which process must be allowed to be completed, whereupon the acknowledgement 406 is sent. Thereafter, the control unit 300 sends (Step 508) appropriate domain-mode signals 408 associated with the request to the domains involved in the synchronisation operation, in this case the first domain 106 and the second domain 108, in order to select correct connections for the domain-internal DFFs. Also, the clock request unit 306 sends (Step 510) clock control signals 410 to the clock control unit 114 in order to configure the clock signals generated by the clock control unit 114.

Once the necessary information has been communicated between the control unit 300 and the SoC device 100, a clocking schema is applied (Step 510) so that the SoC device is triggered to implement the operation request 400 and a synchronisation operation is performed (Step 512) between the first core 204 and the second core 210. In this example, the type of synchronisation that can be performed is either a lock-step type synchronisation or a decoupled parallel synchronisation. However, the skilled person should appreciate that these are simply examples of types of synchronisation techniques. Indeed, different types of synchronisation configuration can be employed.

In this respect, the synchronisation between the domains can be implemented using a master-slave configuration or using a synchronisation master. In the former implementation, one of the first and second cores 202, 204 acts as a synchronisation master and the other core acts as a synchronisation slave, for example (FIG. 7) the first core 202 is the synchronisation master 700 and the second core 204 is the synchronisation slave 702, the first core 202 thereby acting as a reference for the synchronisation process. In this example, FIG. 7 only shows one of a large number of DFF/multiplexer units that are actually employed and arranged to support the master-slave synchronisation process for the sake of simplicity and clarity of description. If a separate synchronisation master arrangement is employed (FIG. 8), the synchronisation control unit 230 acts as a synchronisation master for both the first and second cores 202, 204 and controls the synchronisation process, for example applying a clocking schema and/or triggering a start of a synchronisation process. In such an example, as mentioned above, the synchronisation control unit 230 serves as the synchronisation master 700 and the first and second cores 202, 204 serve as the synchronisation slaves 702. In FIG. 8, one of a large number of DFF/multiplexer units for each of the first and second cores 202, 204 that are actually employed are only shown for the sake for simplicity and clarity of description.

In any event, the use of the control unit 300 enables the type of synchronisation technique being employed to be dynamically changed without resetting the SoC device 100. In this respect, the ability to change the type of synchronisation technique employed is useful, for example in instances where cores are in lock step with each other, but an asynchronism has developed, the cores can be resynchronised using a small number of clock cycles as opposed to resetting a core and restarting an application de novo. Similarly, if the cores run in a decoupled parallel mode, but an application being run by one of the cores requires a rapid change to lockstep synchronisation between the cores, for example in relation to safety critical applications, the need to perform a lengthy reset of the cores followed by a startup sequence for both cores in lockstep mode is avoided.

As the synchronisation process is relatively quick, the control unit 300 waits a predetermined period of time before sending (Step 516) status data 412 to the mode controller unit 112 and/or other functional units of the SoC device 100. The state machine 304 also updates (Step 518) one or more registers associated with synchronisation of the first and second domains 106, 108. Thereafter, the state machine 304 sends (Step 520) a mode change request 414 to the mode controller unit 112 to instruct the first and second domains 106, 202, 208, 210 to revert to the application modes in which the first and second domains 106, 202, 208, 210 were prior to entering the synchronisation mode.

Of course, in relation to other processes, for example an analogue self-check process, the logic performing this process may take longer and a mode completed message may need to be sent. In such circumstances, once the synchronisation of such an operation has been completed, and assuming the second logic area 212 is configured to support self-testing, the second logic area 212 sends (Step 514) a mode completed message and the state machine 304 of the control unit 300 sends (Step 516) status data 412 to the mode controller unit 112 and/or other functional units of the SoC device 100 that may require the status data 412, for example for debugging purposes.

In relation to other processes, for example the self-test process, the skilled person should appreciate that one or more of the first, second and/or third logic areas 200, 206, 208 and/or the first and/or second built-in self-test areas 210, 212 can be configured in the above-described manner to implement a self-test mode under the control of the synchronisation control unit 230 substantially contemporaneously with the performance of the synchronisation process described above. In this example, the first and second memory domains are in normal application modes substantially contemporaneously with the execution of the synchronisation process mentioned above. However, the skilled person should appreciate that other domain modes can be implemented by the first and second memory domains. Indeed, this principle of operation is not exclusive to memory domains and is applicable to other, non-memory, domains described herein. The state machine 304 also updates (Step 518) one or more registers associated with synchronisation of the first and second domains 106, 202, 108, 210 in order to maintain up-to-date information about on-going and completed processes, for example a synchronisation process, so that an intended application of the type mentioned above can, for example, use this up-to-date information to influence further actions of the application. Thereafter, the state machine 304 sends (Step 520) a mode change request 414 to the mode controller unit 112 to instruct the first and second domains 106, 202, 208, 210 to revert to the application modes in which the first and second domains 106, 202, 208, 210 were prior to entering the synchronisation mode.

It is thus possible to provide an apparatus and method that enables one or more domains of a system on chip to execute in different modes of operation locally and at different times. Consequently, one or more domains of the SoC device can be placed in a test mode whilst another domains of the SoC device can execute in other modes of operation different to the test mode, for example an application mode. This means that different domains can run in different modes of operation independently when the SoC device is in being used in an application mode of operation. It is therefore possible to provide partial and parallel self-testing and/or synchronisation of different domains of an SoC whilst an application is being run by the SoC, i.e. other parts of the SoC device remain functional and so not need to be reset.

Modes of operation of a domain can also be accessed easily by the controller unit as well as being easily controlled by software and/or via a Central Processing Unit (CPU). Furthermore, existing design for test logic can be reused, thereby avoiding the need for dedicated logic to support the ability to place domains in different modes of operation so that the domains are simultaneously in the different modes of operation. Also, it is possible to support the adaptation or access of self-test and error-injection modes, for example where the control unit 300 acts as a source of one or more synthetic errors that are in injected or communicated to another, error receiving, domain for testing purposes. In relation to synchronisation of domains, it is not necessary to reset the SoC device when the synchronisation mode has to be switched between lock step mode and decoupled parallel mode.

Of course, the above advantages are exemplary, and these or other advantages may be achieved by the invention. Further, the skilled person will appreciate that not all advantages stated above are necessarily achieved by embodiments described herein.

In the foregoing specification, the invention has been described with reference to specific examples of embodiments of the invention. It will, however, be evident that various modifications and changes may be made therein without departing from the broader spirit and scope of the invention as set forth in the appended claims. For example, the control unit 300 may be supported on the system-on-chip device 100 instead of being external to the system-on-chip device 100 as illustrated in FIG. 3. Accordingly, unless implied or stated otherwise the control unit 300 can be formed as part of the system-on-chip device or external to the system-on-chip device 100. It should also substantially contemporaneously be appreciated that the third and/or fourth domains can be in an active mode of operation that differs from that of the first and/or second domain. Again, this can be controlled by the control unit.

Some of the above embodiments, as applicable, may be implemented using a variety of different information processing architectures for systems on chips. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of the system-on-chip device 100 are circuitry located on a single integrated circuit or within a same device. Alternatively, the system-on-chip device 100 may include any number of separate integrated circuits or separate devices interconnected with each other. For example, the second memory built-in self-test area 222 may be located on a same integrated circuit as the synchronisation domain 200 or on a separate integrated circuit or located within another device, peripheral or slave discretely separate from other elements of system-on-chip device 100.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

The examples set forth herein, or portions thereof, may be implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

1. A system-on-chip (SoC), comprising:
a plurality of functional domains, the plurality of functional domains comprising a first domain and a second domain, wherein
the first domain has a first active mode of operation,
the second domain has a second active mode of operation different from the first active mode of operation;
a control unit operably coupled to the first and second domains and configured to place the first domain in the first active mode and the second domain in the second active mode wherein the first domain is in the first active mode and the second domain is in the second active mode substantially contemporaneously; and
the first active mode of operation is functionally different from the second active mode of operation.

2. An SoC as claimed in claim 1, wherein the plurality of domains comprises a third domain configured to be placed in a third active mode of operation so that the third domain is in the third active mode of operation substantially contemporaneously with the first domain being in the first active mode, the third active mode of operation being different from the first active mode of operation.

3. An SoC as claimed in claim 2, wherein the control system is arranged to control placing, when in use, the third domain into the third active mode of operation.

4. An SoC as claimed in claim 1, wherein the system-on-chip device further comprises a mode controller unit operably coupled to the first and second domains.

5. An SoC as claimed in claim 4, wherein the control unit is configured to communicate with the mode controller unit.

6. An SoC as claimed in claim 5, wherein the control unit is arranged to instruct the mode controller unit to place the first domain into the first active mode of operation in response to a first operation request.

7. An SoC as claimed in claim 5, wherein the control unit is arranged to instruct the mode controller unit to place the second domain into the second active mode of operation in response to a second operation request.

8. An SoC as claimed in claim 5, wherein the control unit is arranged to instruct the mode controller unit to place the third domain into the third active mode of operation in response to a third operation request.

9. An SoC as claimed in claim 1, wherein the control unit comprises a register unit comprising a plurality of registers arranged to support data storage for implementing an operation request.

10. An SoC as claimed in claim 1, wherein the control unit comprises control logic arranged to implement instructing the mode controller unit in relation to changing domain modes of operation.

11. An SoC as claimed in claim 10, wherein the control unit comprises a state machine.

12. An SoC as claimed in claim 3, wherein the control unit comprises a clock request unit arranged to set a clock of the system-on-chip device.

13. An SoC as claimed in claim 1, wherein the first active mode of operation is a test mode, a scan mode, a synchronisation mode, an error-injection mode or an application mode.

14. An SoC as claimed in claim 1, wherein the second active mode of operation is a test mode, a scan mode, a synchronisation mode, an error-injection mode or an application mode.

15. A method of controlling a system-on-chip that comprises a plurality of functional domains, the method comprising:
placing a first domain of the plurality of functional domains into a first active mode of operation; and
placing a second domain of the plurality of functional domains into a second active mode of operation from the first active mode of operation; wherein
the first domain is in the first active mode and the second domain is in the second active mode substantially contemporaneously; and
the first active mode of operation is functionally different from the second active mode of operation.

16. A method of manufacturing a system-on-chip (SoC), the method comprising:
logically segmenting in the design of the system-on-chip device so as to define a plurality of functional domains, the segmenting comprising:
arranging in the design a first portion of the SoC in accordance with a first criterion so as to define a first domain capable of supporting a first active mode of operation;
arranging in the design a second portion of SoC in accordance with a second criterion so as to define a second domain capable of supporting placing the second domain into a second active mode of operation from the first active mode of operation;
providing in the design a control unit operably coupled to the first domain and the second domain and configuring the control unit in order to be able to place, when in use, the first domain in the first active mode and the second domain in the second active mode from the first active mode of operation so that the first domain is in the first active mode and the second domain is in the second active mode substantially contemporaneously; wherein
the first active mode of operation is functionally different from the second active mode of operation.

17. A method as claimed in claim 16, further comprising manufacturing an integrated circuit according to the design.
